(19) United States
(12) Patent Application Publication
(10) Pub. No.: US 2015/0364835 A1
(43) Pub. Date: Dec. 17, 2015

(54) METHOD OF MANUFACTURING CONNECTION STRUCTURAL BODY, CONNECTION STRUCTURAL BODY, WIRE HARNESS, CRIMPING MEMBER AND CRIMPING DEVICE

(71) Applicants: FURUKAWA ELECTRIC CO., LTD., Tokyo (JP); FURUKAWA AUTOMOTIVE SYSTEMS, INC., Shiga (JP)

(72) Inventors: Takashi TONOIKE, Shiga (JP); Yukihiro KAWAMURA, Shiga (JP); Masakazu KOZAWA, Shiga (JP); Takurou YAMADA, Shiga (JP); Kyota SASAI, Tokyo (JP); Akira TACHIBANA, Tokyo (JP)

(73) Assignees: FURUKAWA ELECTRIC CO., LTD., Tokyo (JP); FURUKAWA AUTOMOTIVE SYSTEMS, INC., Shiga (JP)

(21) Appl. No.: 14/832,880

(22) Filed: Aug. 21, 2015

Related U.S. Application Data
(63) Continuation of application No. PCT/JP2014/050305, filed on Jan. 10, 2014.

(30) Foreign Application Priority Data
Feb. 23, 2013 (JP) 2013-033980
Feb. 23, 2013 (JP) 2013-034002
Feb. 24, 2013 (JP) 2013-034037
Jun. 26, 2013 (JP) 2013-134092

(51) Int. Cl. H01R 4/18; H01R 43/048

(52) U.S. Cl. CPC H01R 4/18; H01R 43/048

(57) ABSTRACT

In a method of manufacturing a connection structural body where an insulated wire and a crimp terminal are connected by crimping to each other by the crimping section, the crimping section is configured to have a hollow cross-sectional shape, and is formed by arranging a conductor crimping section which crimps a conductor tip and a cover crimping section which crimps a cover tip in this order from a distal end side to a proximal end side in a long length direction, a portion on the distal end side of the crimping section is sealed, and the crimping of the conductor crimping section is started prior to the crimping of the cover crimping section at the time of connecting the crimping section to the wire tip by crimping.

### TECHNICAL FIELD

This invention relates to a method of manufacturing a connection structural body which can be mounted on a connector of a wire harness for an automobile or the like, for example, a connection structural body, a wire harness, a crimping member and a crimping device.

### BACKGROUND ART

Electric equipment mounted on an automobile or the like is connected to other electric equipment or a power source device through a wire harness which is formed by binding insulated wires thus providing an electric circuit. In this case, the wire harness is connected to the electric equipment or the power source device by connecting connectors which are mounted on these components. A connection structural body where a crimp terminal is connected to an insulated wire by crimping is mounted on the above-mentioned connector.

Recently, electrical components are required to have multiple functions and high performance. To satisfy such requirements, electric circuits are becoming more and more complicated, and the more reliable conductivity is required at a crimping connecting section between each crimp terminal and an insulated wire. Accordingly, when an open-barrel-type crimp terminal is used, a crimping section is exposed to a severe in-use environment and hence, a surface of the crimping section or a surface of a conductor in the crimping connecting section may corrode thus giving rise to a possibility that conductivity is lowered.

To cope with such a drawback, for example, it is estimated that, with the use of a crimp terminal provided with a closed-barrel-type crimping section which is described in paragraph [0005] of Patent Document 1, corrosion which may occur on a surface of a crimping section or a surface of a conductor in a crimping connecting section can be prevented.

As such a closed-barrel-type crimp terminal, there is a crimp terminal disclosed in Patent Document 2 shown below, for example. As disclosed in FIG. 10 to FIG. 15 of Patent Document 2, the crimp terminal disclosed in Patent Document 2 includes a cylindrical crimping section on one end thereof in the long length direction, and such a cylindrical crimping section has one end thereof closed. It is considered that, by inserting and crimping a distal end portion of an insulated wire to the cylindrical crimping section, the crimp terminal disclosed in Patent Document 2 can prevent corrosion which may occur on a surface of the crimping section or on a surface of the conductor in the crimping connecting section.

However, in an actual use, with the mere use of a crimp terminal which includes a closed-barrel-type crimping section, the crimp terminal cannot suppress corrosion to an extent that the crimp terminal can withstand a practical use. Accordingly, it is necessary to seal the crimping section using a water-blocking material or a resin material such as a mold resin and hence, the number of man-hours and cost are pushed up.

Further, the above-mentioned connector is used in various environments and hence, there may be a case where unintended moisture adheres to a surface of an insulated wire due to condensate or the like which is generated because of a change in ambient temperature. When moisture intrudes into the inside of the connector along the surface of the insulated wire, there arises a possibility that a surface of a wire conductor exposed from a distal end of the insulated wire corrodes.

Further, when a distal-end-side end portion of the crimping section is sealed in the closed-barrel-type crimp terminal, air present in the inside of the crimp terminal in a pre-crimping state is not released to the outside at the time of crimping and remains between the crimp terminal and the wire conductor thus giving rise to a drawback that conductivity between the crimp terminal and the insulated wire is deteriorated.

### PRIOR ART DOCUMENTS

### Patent Documents

Patent Document 1: Japanese Patent No. 4,598,039

Patent Document 2: U.S. Pat. No. 3,955,044

### SUMMARY OF THE INVENTION

### Problems to be Solved by the Invention

It is an object of this invention to provide a method of manufacturing a connection structural body which can enhance conductivity between a crimp terminal and an insulated wire, a connection structural body, a wire harness, a crimping member and a crimping device.

### Solutions to the Problems

This invention is directed to a method of manufacturing a connection structural body where an insulated wire formed by covering a conductor with an insulating cover and a crimp terminal provided with a crimping section which allows the crimping connection of a wire tip of the insulated wire are connected by crimping to each other by the crimping section, wherein the wire tip is constituted of a conductor tip which is formed by exposing the conductor by peeling off the insulating cover on a distal end side of the insulated wire, and a cover tip formed on a distal end portion of the insulating cover, the crimping section is configured to have a hollow cross-sectional shape, and is also configured by arranging a conductor crimping section which crimps the conductor tip and a cover crimping section which crimps the cover tip, the crimping section is configured to have a hollow cross-sectional shape, and a sealing portion is formed by sealing a portion on the distal end side of the crimping section, and the wire tip is arranged in the inside of the crimping section and the crimping of the conductor crimping section is started prior to the crimping of the cover crimping section in a crimping step of connecting the crimping section to the wire tip by crimping.

The above-mentioned crimp terminal includes a connection terminal having a connecting portion which allows the connection with a connecting portion of the other terminal of a set of terminals forming a pair or a terminal which is constituted of only a crimping section where a portion on a distal end side is sealed.

According to this invention, conductivity between the crimp terminal and the insulated wire can be enhanced.

This will be described in more detail. When crimping of the conductor crimping section starts, air present between the conductor crimping section and the conductor tip moves toward a proximal end side of the crimping section by depressing. When the crimping of the cover crimping section starts, air present between the cover crimping section and the cover tip cannot move toward a distal end side of the crimping section, moves toward a proximal end side, and is released to the outside from an opening of the crimping section on a proximal end side. As a result, the method of manufacturing a connection structural body can largely decrease air between the crimping section and the wire tip and hence, the adhesion between the crimp terminal and the insulated wire can be enhanced. Accordingly, the method of manufacturing a connection structural body can enhance the conductivity between the crimp terminal and the insulated wire.

As one mode of this invention, in the crimping step, the crimping may be started toward a proximal-end-side end portion of the conductor crimping section from a distal-end-side end portion of the conductor crimping section sequentially.

According to this invention, in the method of manufacturing a connection structural body, air present between the conductor crimping section and the conductor tip may be easily moved toward the proximal end side of the crimping section.

As another mode of this invention, in the crimping step, the crimping is started toward a proximal-end-side end portion of the cover crimping section from a distal-end-side end portion of the cover crimping section sequentially.

According to this invention, in the method of manufacturing a connection structural body, air present between the cover crimping section and the cover tip may be easily moved toward the proximal end side of the crimping section.

As one mode of this invention, in the crimping step, the crimping of the conductor crimping section and the crimping of the cover crimping section may be performed in a same step.

Due to this invention, in the method of manufacturing a connection structural body, it is unnecessary to perform the crimping of the conductor crimping section and the crimping of the cover crimping section in different steps and hence, the manufacturing process can be simplified.

As one mode of this invention, in the crimping step, the crimping of the conductor crimping section and the crimping of the cover crimping section may be performed in different steps.

Due to this invention, in the method of manufacturing a connection structural body, the crimping of the proximal-end-side end portion of the conductor crimping section can be easily started prior to the crimping of the distal-end-side end portion of the cover crimping section.

This invention is also directed to a method of manufacturing a connection structural body where an insulated wire formed by covering a conductor with an insulating cover and a crimp terminal provided with a crimping section which allows the crimping connection of a wire tip of the insulated wire are connected by crimping to each other by the crimping section, wherein the wire tip is constituted of a conductor tip which is formed by exposing the conductor by peeling off the insulating cover on a distal end side of the insulated wire, and a cover tip formed on a distal end portion of the insulating cover, the crimping section is configured to have a hollow cross-sectional shape, and is also configured by arranging a conductor crimping section which crimps the conductor tip and a cover crimping section which crimps the cover tip, the crimping section is configured to have a hollow cross-sectional shape, and a sealing portion is formed by sealing a portion on the distal end side of the crimping section, and the crimping of a portion of the insulated wire having a smaller radial cross-sectional area in a radial direction of the insulated wire in a post-crimping state is started prior to the crimping of a portion of the insulated wire having a larger radial cross-sectional area in the radial direction of the insulated wire in the post-crimping state in a crimping step of connecting the crimping section to the wire tip by crimping.

The portion of the insulated wire having a smaller radial cross-sectional area in the post-crimping state may be a crimped portion between the conductor crimping section and the conductor tip in the connection structural body.

The portion of the insulated wire having a larger radial cross-sectional area in the post-crimping state may be a crimped portion between the cover crimping section and the cover tip in the connection structural body.

According to this invention, conductivity between the crimp terminal and the insulated wire can be enhanced.

This invention is also characterized by a connection structural body manufactured by the above-mentioned method of manufacturing a connection structural body.

According to this invention, conductivity between the crimp terminal and the insulated wire can be enhanced.

According to another aspect of this invention, the crimp terminal may be made of copper or a copper alloy, and the conductor of the insulated wire may be made of aluminum or an aluminum alloy.

Due to this invention, the insulated wire can be light-weighted compared to an insulated wire having a conductor portion made of a copper wire and, at the same time, the reliable water-blocking performance can be acquired by the above-mentioned sealing portion and hence, so-called dissimilar metal contact corrosion (hereinafter referred to as “galvanic corrosion”) can be prevented.

This will be described in more detail. When a copper-based material which has been conventionally used as a conductor of an insulated wire is replaced with an aluminum-based material such as aluminum or an aluminum alloy, and the conductor made of the aluminum-based material is crimped to a crimp terminal, due to contact between the aluminum-based material and a nobler metal material such as tin plating, gold plating or a copper alloy which is a material for forming a terminal, there arises a phenomenon that the aluminum-based material which is a less noble metal corrodes, that is, a galvanic corrosion, as a drawback.

“Galvanic corrosion” is a phenomenon that when moisture adheres to a portion where a nobler metal material and a less noble metal contact with each other, a corrosion electric current is generated, and the less noble metal corrodes, is melted and is dissipated and the like. Due to such a phenomenon, a conductor made of an aluminum-based material crimped to a crimping section of a crimp terminal corrodes, is melted and is dissipated and, eventually, electric resistance is increased. As a result, there arises a drawback that the crimp terminal cannot give a sufficient conduction performance.

However, by connecting the above-mentioned conductor by crimping in a state where the conductor is being inserted into the inside of the crimping section in place, it is possible to prevent so-called galvanic corrosion while making the insulated wire light-weighted compared to an insulated wire having a conductor made of a copper-based material.

As a result, the connection structural body can provide a connection state which ensures stable conductivity between the crimp terminal and the insulated wire irrespective of the type of a metal which is used for forming the crimp terminal and the conductor of the insulated wire.

According to another aspect of this invention, there is provided a wire harness configured such that a plurality of above-mentioned connection structural bodies are bound together and the crimp terminals of the connection structural bodies are mounted in the inside of a connector housing.

According to this invention, with the use of the connection structural body which enhances the conductivity between the crimp terminal and the insulated wire, it is possible to provide the wire harness which ensures the favorable conductivity.

According to another aspect of this invention, there is provided a crimping member for connecting a wire tip of an insulated wire formed by covering a conductor with an insulating cover to a crimp terminal by crimping in a state where the wire tip is arranged in the inside of the crimp terminal, the crimping member including: a portion which crimps a conductor tip formed by exposing the conductor by peeling off the insulating cover on a distal end side of the insulated wire; and a portion which crimps a cover tip formed on a distal end portion of the insulating cover, wherein the crimping of the portion which crimps the conductor tip is started prior to the crimping of the portion which crimps the cover tip by bringing the portion which crimps the conductor tip into contact with the crimp terminal earlier than the portion which crimps the cover tip.

According to this invention, the conductivity between the crimp terminal and the insulated wire can be enhanced.

According to another aspect of this invention, there is also provided a crimping device for connecting a wire tip of an insulated wire formed by covering a conductor with an insulating cover by crimping to a crimp terminal in a state where the wire tip is arranged in the inside of the crimp terminal, wherein the crimping device includes a crimping member which is configured to crimps the crimp terminal such that the crimping of a conductor tip which is formed by exposing the conductor by peeling off the insulating cover on a distal end side of the insulated wire is started prior to the crimping of a cover tip formed on a distal end portion of the insulating cover.

According to this invention, the conductivity between the crimp terminal and the insulated wire can be enhanced.

As another aspect of this invention, the crimping member is constituted of a first die and a second die which engages with the first die, a recessed portion is formed at a position of the first die which faces the second die in an opposed manner, the recessed portion is constituted of a bottom portion which defines a shape of the crimp terminal in a post-crimping state, and a communicating portion which makes the bottom portion and the outside communicate with each other, and has a width thereof when viewed in a cross section having a normal line along a long length direction of the crimp terminal increased toward an opening portion of the recessed portion from a boundary portion between the communicating portion and the bottom portion, and the width of the communicating portion at a specified depth at a first position along the long length direction is set smaller than the width at the specified depth of the communicating portion at a second position different from the first position in the long length direction.

According to this invention, the width of the communicating portion at the specified depth at the first position is set smaller than the width at the specified depth of the communicating portion at the second position and hence, a portion of the crimp terminal which depresses the conductor tip and the wall surface of the communicating portion at the first position are brought into contact with each other so that the crimping of the conductor tip starts. At this stage, a portion of the crimp terminal which depresses the cover tip and the wall surface of the communicating portion at the second position are not brought into contact with each other so that the crimping device does not start the crimping of the cover tip. As a result, the crimping device can start the crimping of the conductor tip prior to the crimping of the cover tip.

According to another aspect of this invention, there is also provided a crimping device for connecting a wire tip of an insulated wire formed by covering a conductor with an insulating cover by crimping to a crimping section in a state where the wire tip is arranged in the inside of the crimping section of the crimp terminal, wherein the crimping device includes a crimping member which is configured to crimp the crimping section so as to start the crimping of a portion of the insulated wire having a smaller radial cross-sectional area in a radial direction of the insulated wire in a post-crimping state prior to the crimping of a portion of the insulated wire having a larger radial cross-sectional area in the radial direction of the insulated wire in the post-crimping state.

The portion of the insulated wire having a smaller radial cross-sectional area in the post-crimping state may be a portion formed by the crimping the conductor tip formed by exposing the conductor by peeling off the insulating cover of the insulated wire on a distal end side and the crimping section or the like.

The portion of the insulated wire having a larger radial cross-sectional area in the post-crimping state may be a portion formed by crimping the cover tip which is a distal end portion of the insulating cover and the crimping section or the like.

According to this invention, the conductivity between the crimp terminal and the insulated wire can be enhanced.

### Effects of the Invention

According to this invention, it is possible to provide a method of manufacturing a connection structural body which can enhance conductivity between a crimp terminal and an insulated wire, a connection structural body, a wire harness, a crimping member and a crimping device.

### BRIEF DESCRIPTION OF THE DRAWINGS

FIG. 1A and FIG. 1B are explanatory views showing a crimp-terminal-equipped wire according to a first embodiment.

FIG. 2 is a longitudinal cross-sectional view of a distal end portion of the crimp-terminal-equipped wire at the center in the width direction.

FIG. 3A and FIG. 3B are explanatory views for describing welding at a crimping section.

FIG. 4A and FIG. 4B are explanatory views showing a mode of a crimping step of the crimp-terminal-equipped wire according to the first embodiment.

FIG. 5 is an external appearance perspective view showing a connection correspondence state of a wire harness.

FIG. 6A to FIG. 6E include cross-sectional views showing a relationship between a crimping tool and a wire crimping section in a crimping step of the crimp-terminal-equipped wire according to the first embodiment.

FIG. 7A to FIG. 7D are explanatory views for describing the manner of operation and advantageous effects acquired by a crimping method according to the first embodiment.

FIG. 8A and FIG. 8B are cross-sectional views showing a mode of a crimping step of a crimp-terminal-equipped wire according to a second embodiment.

FIG. 9A and FIG. 9B are cross-sectional views showing another mode of the crimping step according to the second embodiment.

FIG. 10A and FIG. 10B are cross-sectional views showing the other mode of the crimping step according to the second embodiment.

FIG. 11 is a cross-sectional view showing a mode of a crimping step of a crimp-terminal-equipped wire according to a third embodiment.

FIG. 12A to FIG. 12C are cross-sectional views of another crimping section.

FIG. 13A to FIG. 13C are cross-sectional views showing a relationship between another crimping tool and the crimping section.

FIG. 14A and FIG. 14B are cross-sectional views showing another crimped shape at the crimping section of the female-type crimp terminal.

FIG. 15A and FIG. 15B are explanatory views for describing a crimping section of another female-type crimp terminal.

### EMBODIMENTS OF THE INVENTION

One embodiment of this invention is described in detail by reference to the drawings hereinafter.

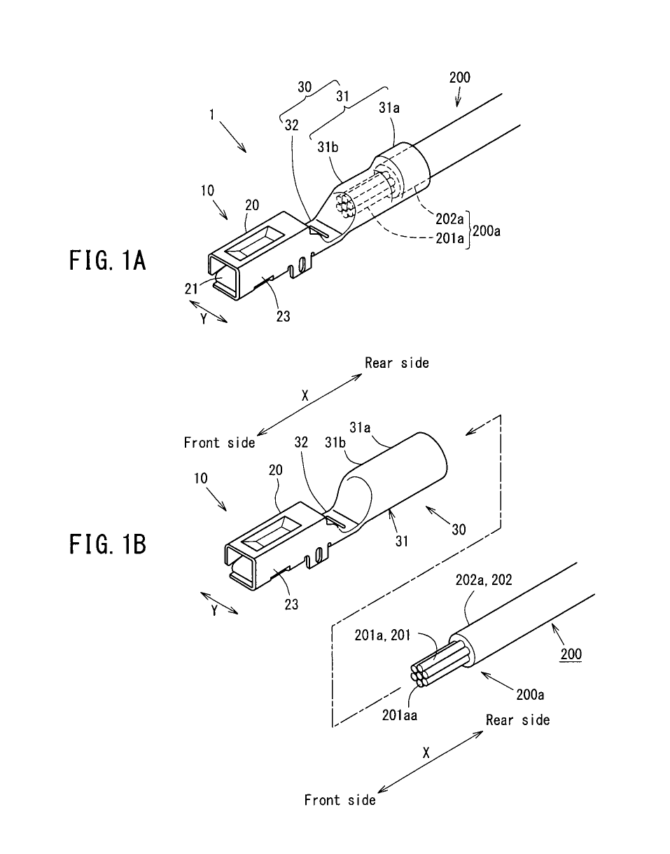

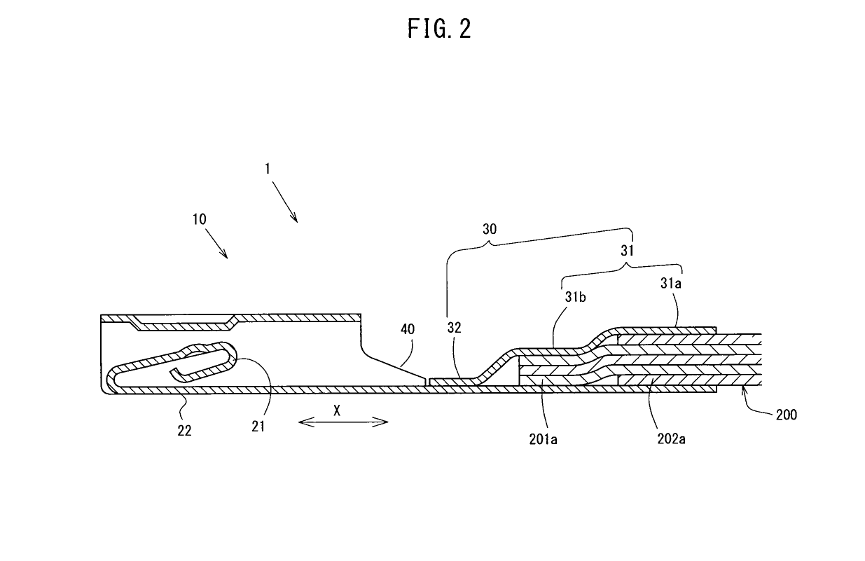

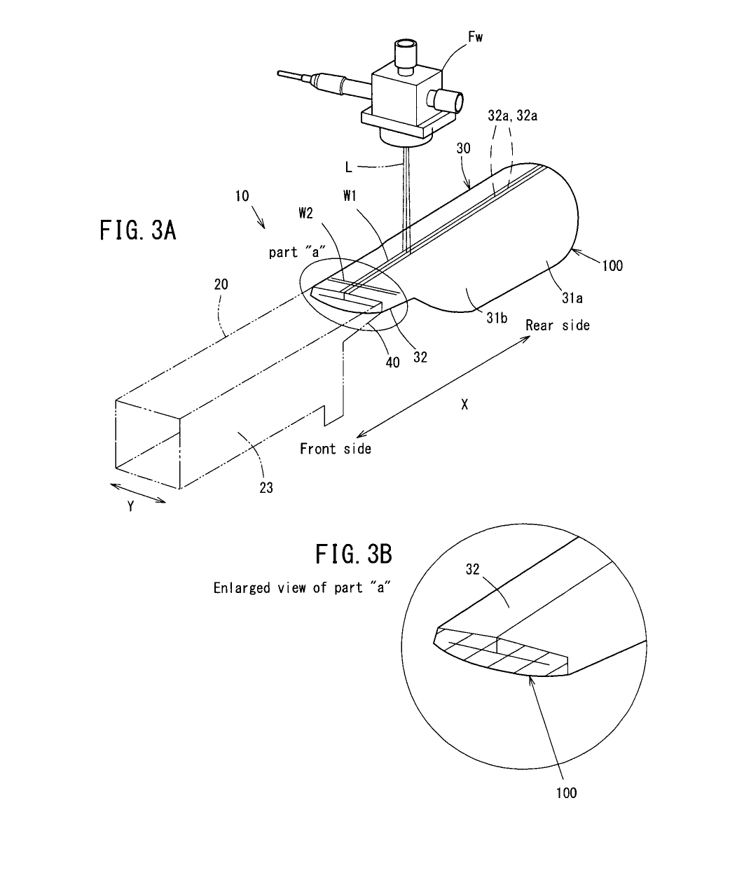

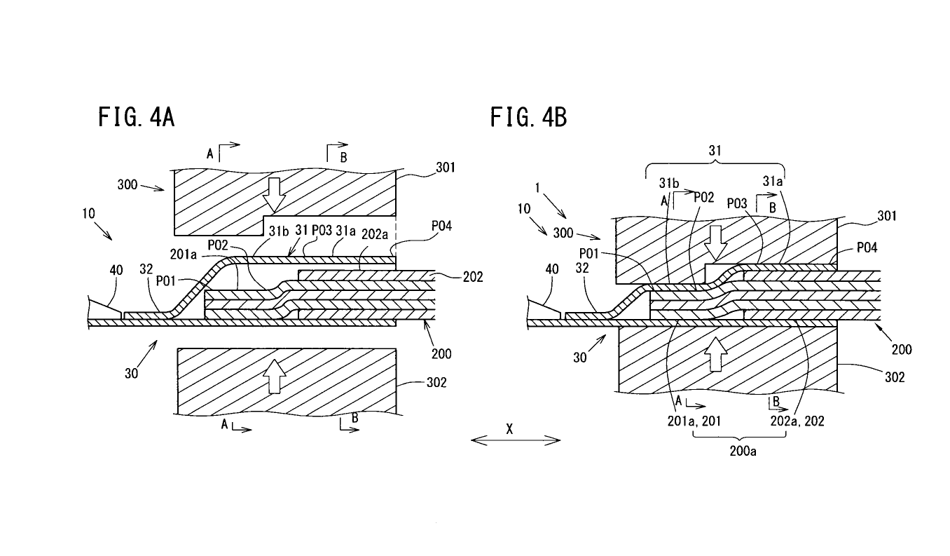

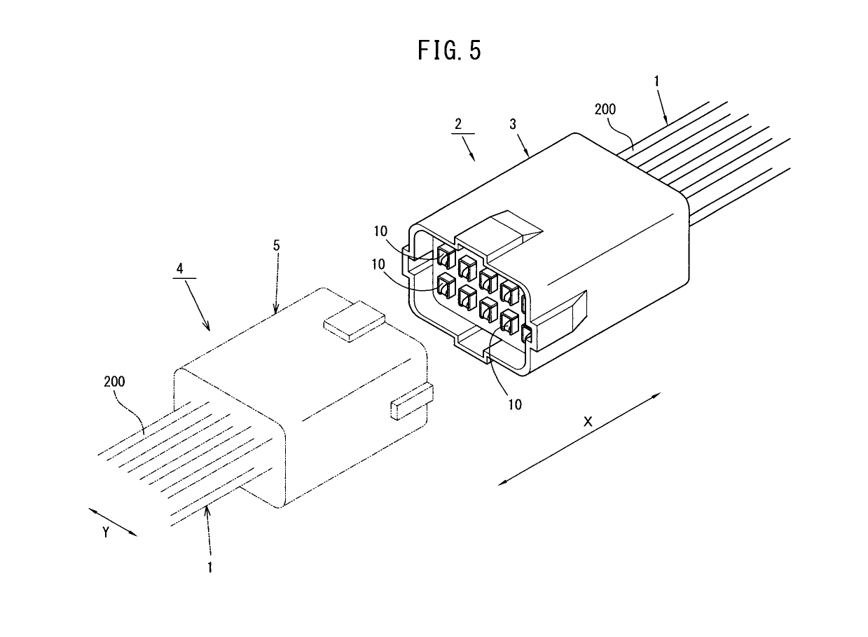

FIG. 1A and FIG. 1B are explanatory views showing a crimp-terminal-equipped wire 1 according to a first embodiment, FIG. 2 is a longitudinal cross-sectional view of a distal end portion of the crimp-terminal-equipped wire 1 at the center in the width direction, FIG. 3A and FIG. 3B are explanatory views for describing welding at a crimping section 30, FIG. 4A and FIG. 4B are explanatory views showing a mode of a crimping step of the crimp-terminal-equipped wire 1 according to the first embodiment, and FIG. 5 is an external appearance perspective view of a connection correspondence state between a wire harness 2 and a wire harness 4. In FIG. 5, the wire harness 4 is illustrated by a double-dashed chain line.

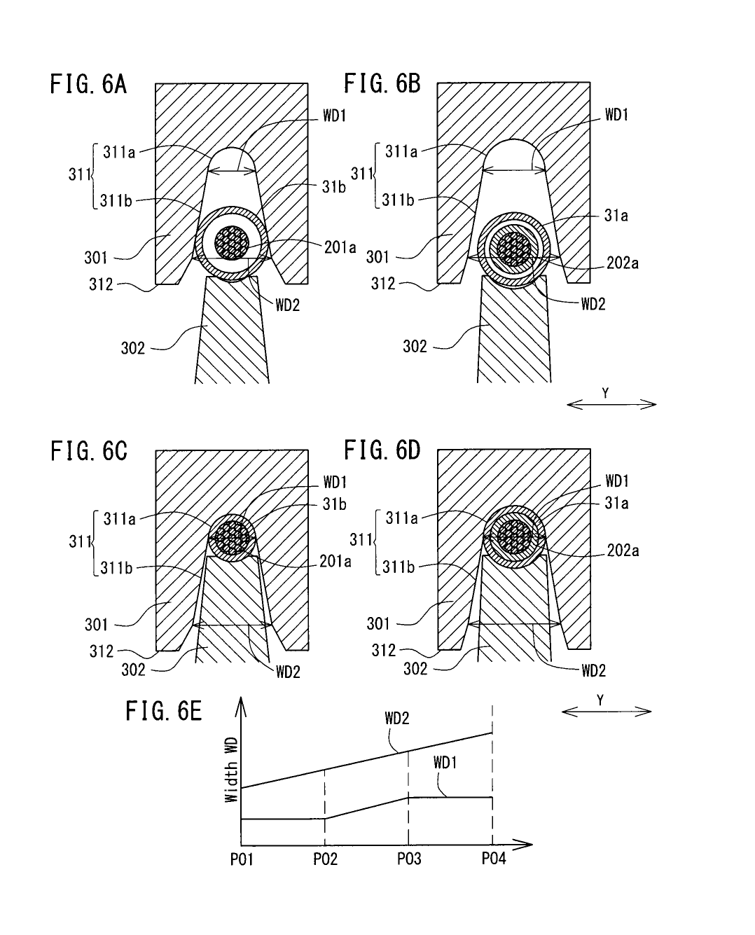

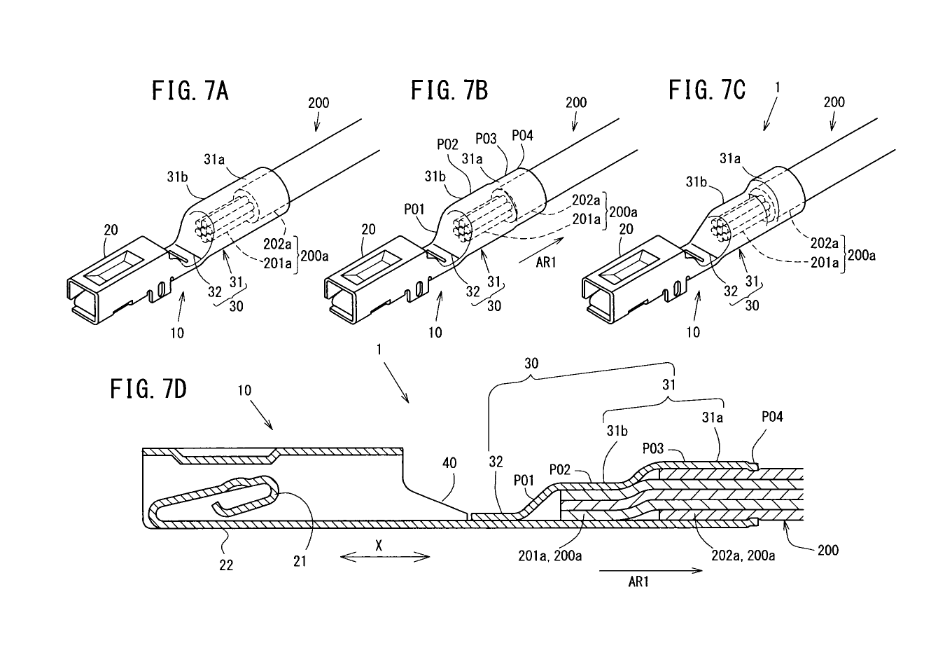

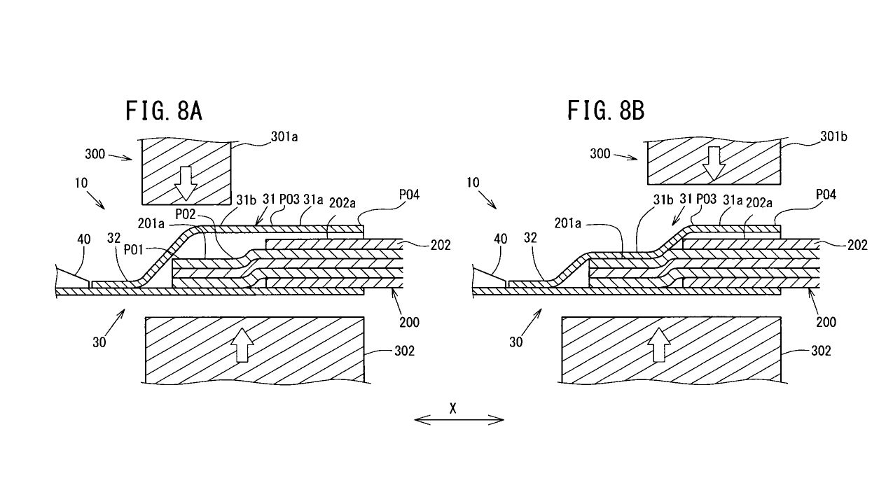

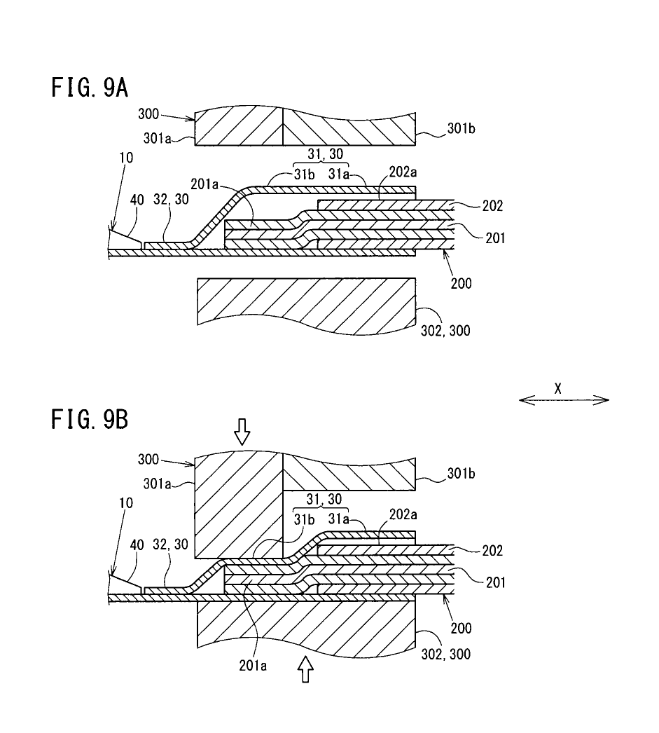

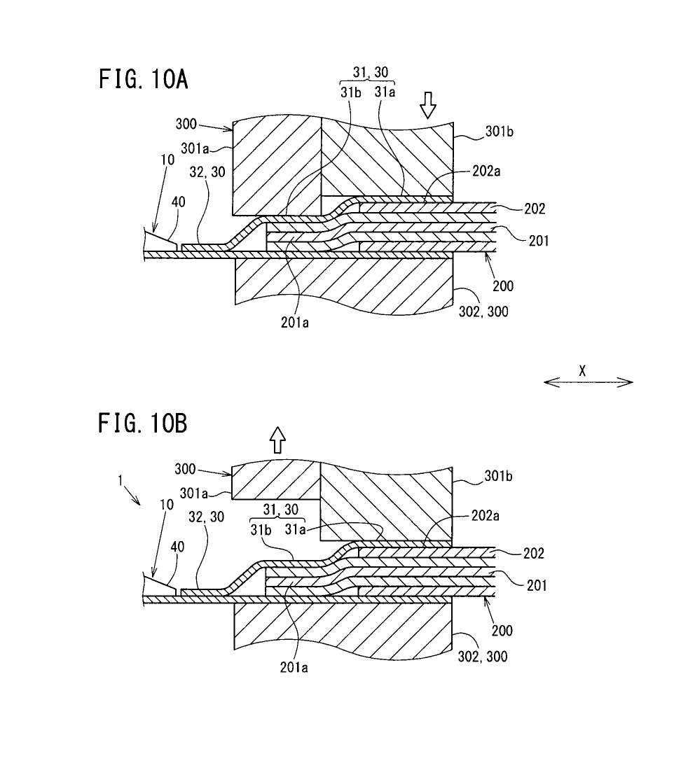

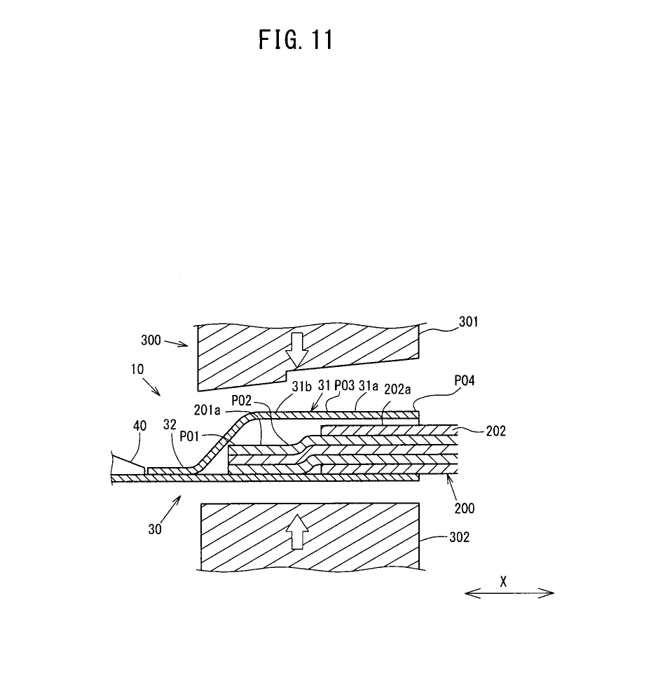

FIG. 6A to FIG. 6E include cross-sectional views showing a relationship between a crimping tool 300 and a wire crimping section 31 in the crimping step of the crimp-terminal-equipped wire 1 according to the first embodiment, FIG. 7A to FIG. 7D are explanatory views for describing a manner of operation and advantageous effects obtained by a crimping method according to the first embodiment, FIG. 8A and FIG. 8B are cross-sectional views showing a mode of a crimping step of a crimp-terminal-equipped wire 1 according to a second embodiment, FIG. 9A and FIG. 9B are cross-sectional views showing a mode of another crimping step according to the second embodiment, FIG. 10A and FIG. 10B are cross-sectional views showing a mode of the other crimping step according to the second embodiment, and FIG. 11 is a cross-sectional view showing a mode of a crimping step of a crimp-terminal-equipped wire 1 according to a third embodiment.

### First Embodiment

A crimp-terminal-equipped wire 1 according to this embodiment is configured such that, as shown in FIG. 1A and FIG. 2, an insulated wire 200 is connected to a female crimp terminal 10. That is, a wire tip 200a of the insulated wire 200 is connected to a crimping section 30 of the female crimp terminal 10 by crimping.

The insulated wire 200 connected to the female crimp terminal 10 by crimping is formed by covering an aluminum core wire 201 formed by binding aluminum raw wires 201aa with an insulating cover 202 made of an insulating resin. This will be described in more detail. The aluminum core wire 201 is formed by stranding aluminum alloy wires such that the aluminum core wire 201 acquires a cross-sectional area of 0.75 mm².

The wire tip 200a is a distal end portion of the insulated wire 200 which includes a cover tip 202a and a conductor tip 201a in series in this order toward a distal end side.

The conductor tip 201a is a portion where the aluminum core wire 201 is exposed by peeling off the insulating cover 202 on a front side of the insulated wire 200.

The cover tip 202a is a portion which forms the distal end portion of the insulated wire 200, and is disposed behind the conductor tip 201a, and where the aluminum core wire 201 is covered with the insulating cover 202.

Hereinafter, a female crimp terminal 10 is described in detail.

The female crimp terminal 10 extends toward a rear side from a front side which is a distal end side in the long length direction X. The female crimp terminal 10 is an integral body formed of; a box section 20 which allows the insertion of an insertion tub of a male terminal not shown in the drawing therein; and the crimping section 30 which is arranged behind the box section 20 with a transition section 40 having a predetermined length interposed therebetween.

In this embodiment, as described above, the female crimp terminal 10 is formed of the box section 20 and the crimping section 30. However, provided that a crimp terminal has the crimping section 30, the crimp terminal may be a male crimp terminal formed of an insertion tub which is inserted into and is connected to the box section 20 in the above-mentioned female crimp terminal 10 and a crimping section 30. Alternatively, the crimp terminal may be a crimp terminal formed of only the crimping section 30 where aluminum core wires 201 of a plurality of insulated wires 200 are bound and connected to the crimp terminal, for example. Further, the crimp terminal may be a crimp terminal which includes a connecting portion having an approximately U-shape or an annular flat plate shape in place of the box section 20.

As shown in FIG. 1A and FIG. 1B, the long length direction X is a direction which agrees with the long length direction of the insulated wire 200 to which the crimping section 30 is connected by crimping. The width direction Y corresponds to the width direction of the female crimp terminal 10 and is a direction which intersects with the long length direction X on the plane direction. Further, a side where a box section 20 is disposed is set as a front side (distal end side) with respect to the crimping section 30, and a side where a crimping section 30 is disposed is set as a rear side (proximal end side) with respect to the box section 20.

The box section 20 is formed of a hollow quadrangular columnar body in a laying-down state. In the inside of the box section 20, a resilient contact lug 21 which is formed by bending toward a rear side in the long length direction X and is brought into contact with the insertion tub (not shown in the drawing) of a male connector to be inserted is disposed.

The box section 20 which constitutes the hollow quadrangular columnar body is formed into an approximately rectangular shape as viewed from a distal end side in the long length direction X by bending, in an overlapping manner, side surface portions 23 which are contiguously formed on both side portions of the bottom surface portion 22 in the width direction Y which intersects with the long length direction X.

The crimping section 30 is an integral body formed of a wire crimping section 31 and a sealing portion 32 which are arranged in this order from a rear side to a front side, and is formed into an integral and contiguous shape over the whole circumference.

The wire crimping section 31 is formed by contiguously arranging a cover crimping section 31a and a conductor crimping section 31b in series from the rear side to the front side in this order. The wire crimping section 31 has a closed barrel-type hollow shape (cylindrical shape) where only a rear side of the wire crimping section 31 is opened, and a distal end side and the whole peripheral surfaces are not opened. The wire tip 200a can be inserted into the wire crimping section 31 through the opening formed on the rear side of the wire crimping section 31 and extends over the cover crimping section 31a to the conductor crimping section 31b.

The cover crimping section 31a is a portion which corresponds to a cover tip 202a of the wire crimping section 31 in the long length direction X in a state where the wire tip 200a is inserted into the wire crimping section 31.

On the other hand, the conductor crimping section 31b is a portion which corresponds to the conductor tip 201a of the wire crimping section 31 in the long length direction X in a state where the wire tip 200a is inserted into the wire crimping section 31.

The cover crimping section 31a and the conductor crimping section 31b are formed into a cylindrical shape, and have approximately the same diameters in a pre-crimping state.

The sealing portion 32 is formed into a flat shape where plate-like portions of a terminal base material which forms the female crimp terminal 10 overlap with each other. The sealing portion 32 is formed by depressing an end portion of the sealing portion 32 in front of the wire crimping section 31 formed into a hollow shape (cylindrical shape) to form an approximately flat plate shape.

Next, a method of manufacturing the above-mentioned female crimp terminal 10 is described by reference to FIG. 3A and FIG. 3B.

FIG. 3A and FIG. 3B are explanatory views for describing welding at the crimping section 30. This will be described in more detail. FIG. 3A is an operation explanatory view showing a mode where a fiber laser welding is performed using a fiber laser welding device Fw, and FIG. 3B is an enlarged view of part “a” in FIG. 3A.

The above-mentioned female crimp terminal 10 is a closed-barrel-type female crimp terminal 10 which is formed by bending the terminal base material 100 into a stereoscopic terminal shape formed of the box section 20 having a hollow quadrangular columnar body and the crimping section 30 having an approximately 0 shape as viewed from a rear side, and by welding the crimping section 30 using a laser L.

The terminal base material 100 is a plate-like base material for forming the female crimp terminal 10. The terminal base material 100 is a plate material formed by blanking a copper alloy strip made of brass or the like (not shown in the drawing) and having a surface thereof plated with tin (Sn plating) in a shape of a terminal developed in plane. The terminal base material 100 includes a crimping surface and barrel forming members extending from both sides of the crimping surface in the width direction Y at portions which correspond to the crimping section 30 in a pre-crimping state.

This will be described in more detail. The female crimp terminal 10 is formed such that barrel forming members of the terminal base material 100 are rounded in the direction having the long length direction X as the center axis and end portions 32a of the barrel forming members are made to abut against each other at a bottom surface side thus forming a cylindrical shape. The pair of opposedly facing end portions 32a of the terminal base material 100 are welded together in a state where the opposedly facing end portions 32a are made to abut against each other while sliding the laser irradiation device Fw along the long length direction X thus forming a welding portion W1 in the long length direction.

Thereafter, a front portion of the crimping section 30 is welded while sliding the laser irradiation device Fw along the long length direction X on a front side of the crimping section 30 thus forming a welding portion W2 in the width direction.

Next, a procedure where the above-mentioned female crimp terminal 10 is connected to the wire tip 200a by crimping is described by reference to FIG. 4A and FIG. 4B.

FIG. 4A and FIG. 4B are operation explanatory views showing a mode of a crimping step of the crimp-terminal-equipped wire 1 according to the first embodiment in cross-section. This will be described in more detail. FIG. 4A is a longitudinal cross-sectional view showing a state immediately before the female crimp terminal 10 is crimped to the wire tip 200a. FIG. 4B is a longitudinal cross-sectional view showing a state immediately after the female crimp terminal 10 is crimped to the wire tip 200a.

First, as shown in FIG. 4A, the wire tip 200a is inserted into the wire crimping section 31 of the crimping section 30. As shown in FIG. 4A, the cover tip 202a of the wire tip 200a is inserted into the inside of the cover crimping section 31a, and the conductor tip 201a of the wire tip 200a is inserted into the inside of the conductor crimping section 31b.

In this state, the wire crimping section 31 is crimped to the wire tip 200a by pressing the wire crimping section 31 using the crimping tool 300 formed of a crimper 301 and an anvil 302 to be engaged with each other.

At the time of performing crimping, as shown in FIG. 4A, the crimper 301 and the anvil 302 are arranged to face each other in an opposed manner with the crimping section 30 interposed therebetween.

By clamping the crimping section 30 using the crimper 301 and the anvil 302 from both sides in this state, the wire crimping section 31 is crimped to the wire tip 200a as shown in FIG. 4B.

Accordingly, as shown in FIG. 2, the female crimp terminal 10 is connected to the wire tip 200a of the insulated wire 200 by crimping.

For example, as shown in FIG. 5, a plurality of crimp-terminal-equipped wires 1 crimped in this manner are bound together and the female crimp terminals 10 are mounted in the inside of a female connector housing 3 thus constituting a wire harness 2.

This will be described in more detail. The wire harness 2 is constituted of the plurality of crimp-terminal-equipped wires 1 and the female connector housing 3.

The female connector housing 3 is formed into a box shape having an approximately rectangular cross-sectional shape in the width direction Y. A plurality of cavities into each of which the female crimp terminal 10 is mounted along the long length direction X are formed in the female connector housing 3. The wire harness 2 is constituted by mounting the plurality of crimp-terminal-equipped wires 1 formed of the above-mentioned female crimp terminal 10 in the inside of the female connector housing 3 along the long length direction X.

A wire harness 4 which engages with the wire harness 2 by female-male fitting includes a male connector housing 5 corresponding to the female connector housing 3. In the same manner as in the female connector housing 3, the male connector housing 5 has a plurality of openings into each of which a crimp terminal can be mounted in the inside thereof, has an approximately rectangular cross-sectional shape in the width direction Y, and is connectable with the female connector housing 3 based on the concave and convex relationship.

The wire harness 4 is formed by mounting the crimp-terminal-equipped wires 1 constituted of the male crimp terminal not shown in the drawing in the inside of the male connector housing 5 along the long length direction X.

Then, by making the female connector housing 3 and the male connector housing 5 engage with each other by fitting engagement, the wire harness 2 and the wire harness 4 can be electrically connected to each other.

Next, the detailed constitution of the crimping tool 300 used in the above-mentioned crimping step and the behavior of the wire crimping section 31 in the crimping step are described in detail.

FIG. 6A to FIG. 6D are cross-sectional views showing a relationship between the crimping tool 300 and the wire crimping section 31 in the crimping step of the crimp-terminal-equipped wire 1 according to the first embodiment. This will be described in more detail. FIG. 6A is a cross-sectional view taken along line A-A in FIG. 4A (a cross-sectional view at a position where the conductor crimping section 31b and the conductor tip 201a are present), FIG. 6B is a cross-sectional view taken along line B-B in FIG. 4A (a cross-sectional view at a position where the cover crimping section 31a and the cover tip 202a are present), FIG. 6C is a cross-sectional view taken along line A-A in FIG. 4B (a cross-sectional view at a portion where the conductor crimping section 31b and the conductor tip 201a are present), and FIG. 6D is a cross-sectional view taken along line B-B in FIG. 4B (a cross-sectional view at a portion where the cover crimping section 31a and the cover tip 202a are present).

All of FIG. 6A, FIG. 6B, FIG. 6C and FIG. 6D are cross-sectional views having the long length direction X of the wire crimping section 31 set as a normal line. FIG. 6E is a graph schematically showing a change in width WD1 of the bottom portion 311a and a change in width WD2 of the communicating portion 311b at a portion of the crimper 301 which crimps the wire crimping section 31.

The crimping tool 300 has the constitution shown in FIG. 6A and FIG. 6B. A recessed portion 311 which engages with the anvil 302 is formed in the crimper 301 at a position where the crimper 301 faces the anvil 302 in an opposed manner. The recessed portion 311 is formed of a bottom portion 311a which defines a shape of the cover crimping section 31a and the conductor crimping section 31b in a post-crimping state and the communicating portion 311b which allows the bottom portion 311a and the outside to communicate with each other.

The width WD2 of the communicating portion 311b when viewed in cross section having the long length direction X of the wire crimping section 31 set as a normal line is increased toward an opening portion 312 of the recessed portion 311 from a boundary portion between the bottom portion 311a and the communicating portion 311b. The width WD2 of the communicating portion 311b at a specified depth at a first position (a position of a conductor crimping section 31b) along the long length direction X of the wire crimping section 31 is smaller than the width WD2 of the communicating portion 311b at the specified depth at a second position (a position of the cover crimping section 31a) along the long length direction X of the wire crimping section 31 as shown in FIG. 6A, FIG. 6B and FIG. 6E. It is assumed that the specified depth of the communicating portion 311b at the position of the conductor crimping section 31b and the specified depth of the communicating portion 311b at the position of the cover crimping section 31a are set at the same depth from the opening portion 312.

It is desirable that, as shown in FIG. 6E, the width WD2 is increased toward a position PO2 which is the position of a proximal-end-side end portion of the conductor crimping section 31b from a position PO1 which is the position of a distal-end-side end portion of the conductor crimping section 31b along the long length direction X of the wire crimping section 31, and the width WD2 is increased toward a position PO4 which is the position of a proximal-end-side end portion of the cover crimping section 31a from a position PO3 which is the position of a distal-end-side end portion of the cover crimping section 31a along the long length direction X of the wire crimping section 31. In this case, the crimping of the conductor crimping section 31b can be started toward the proximal end portion from the distal end portion of the conductor crimping section 31b and, thereafter, the crimping of the cover crimping section 31a can be started toward the proximal end portion from the distal end portion of the cover crimping section 31a.

It is also possible to set the width WD2 such that the width WD2 takes a fixed value from the position PO1 to the position PO2, and the width WD2 from the position PO3 to the position PO4 takes a fixed value larger than the width WD2 from the position PO1 to the position PO2. In this case, the crimping can be started simultaneously over the whole conductor crimping section 31b and, thereafter, the crimping can be started simultaneously over the whole cover crimping section 31a.

It may be also possible to set the width WD2 such that the width WD2 is increased toward the position PO2 from the position PO1, while the width WD2 from the position PO3 to the position PO4 takes a fixed value larger than the width WD2 at the position PO2. In this case, the crimping of the conductor crimping section 31b can be started toward the proximal end portion from the distal end portion of the conductor crimping section 31b and, thereafter, the crimping can be simultaneously started over the whole cover crimping section 31a.

Further, it may be also possible to set the width WD2 such that the width WD2 from the position PO1 to the position PO2 takes a fixed value smaller than the width WD2 at the position PO3, and the width WD2 is increased toward the position PO4 from the position PO3. In this case, the crimping can be simultaneously started over the whole conductor crimping section 31b and, thereafter, the crimping of the cover crimping section 31a can be started toward the proximal end portion from the distal end portion of the cover crimping section 31a.

The width WD1 of the bottom portion 311a is set to a fixed value at a portion which presses the cover crimping section 31a and a portion which presses the conductor crimping section 31b irrespective of the position in the long length direction X. The widths WD1 at the portions (positions PO1 and PO2) which press the conductor crimping section 31b are set smaller than the widths WD1 at the portions (positions PO3 and PO4) which press the cover crimping section 31a. A distance of the portion which presses the conductor crimping section 31b from the opening portion 312 at the width WD1 is smaller than a distance of the portion which presses the cover crimping section 31a from the opening portion 312 at the width WD1.

A depth of the bottom portion 311a (a distance from the opening portion 312) at the portions (positions PO1 and PO2) which press the conductor crimping section 31b is set smaller than the depth of the bottom portion 311a at the portions (positions PO3 and PO4) which press the cover crimping section 31a. Accordingly, a reduction ratio of the conductor crimping section 31b by the crimping tool 300 can be increased compared to a reduction ratio of the cover crimping section 31a by the crimping tool 300.

The width WD1 of the bottom portion 311a can be freely set depending on a desired size of the crimp-terminal-equipped wire 1, and the width WD1 of the bottom portion 311a can be made different from each other among the positions PO1, PO2, PO3 and PO4.

By constituting the crimping tool 300 as described above, the crimping of the conductor crimping section 31b can be started prior to the crimping of the cover crimping section 31a. Further, the crimping of the conductor crimping section 31b and the crimping of the cover crimping section 31a can be performed in the same step.

This will be described in more detail. At timing where the crimper 301 and the anvil 302 are disposed at positions shown in FIG. 4A, as shown in FIG. 6A, the conductor crimping section 31b is brought into contact with a wall surface of the communicating portion 311b of the crimper 301 and hence, the crimping of the conductor tip 201a and the crimping of the conductor crimping section 31b are started. On the other hand, at timing where the crimper 301 and the anvil 302 are disposed at positions shown in FIG. 4A, as shown in FIG. 6B, the cover crimping section 31a is not yet brought into contact with the crimper 301 and hence, the crimping of the cover tip 202aand the crimping of the cover crimping section 31a are not started. That is, the crimping of the cover crimping section 31a is started after the crimping of the conductor crimping section 31b is started.

As shown in FIG. 6E, when the width WD2 is increased toward the position PO4 from the position PO1 along the long length direction X of the wire crimping section 31, the crimping is sequentially started toward the position PO4 from the position PO1 in the order from the position PO1, the position PO2, the position PO3 and the position PO4 with time.

At timing where the crimper 301 and the anvil 302 are disposed at positions shown in FIG. 4B (timing where the crimping is finished), as shown in FIG. 6C and FIG. 6D, the cover crimping section 31a and the conductor crimping section 31b are crimped by the wall surface of the bottom portion 311a, and the shape of the cover crimping section 31a and the shape of the conductor crimping section 31b are defined by the bottom portion 311a.

When the width WD1 of the bottom portion 311a is fixed irrespective of the position on the cover crimping section 31a in the long length direction X, a width of the cover crimping section 31a is uniform along the long length direction X of the cover crimping section 31a. When the width WD1 of the bottom portion 311a is fixed irrespective of the position on the conductor crimping section 31b in the long length direction X, a width of the conductor crimping section 31b is uniform along the long length direction X of the conductor crimping section 31b.

The manner of operation and the advantageous effects acquired by the crimping method described above are described.

As shown in FIG. 7A, when the crimping is started in a state where the wire tip 200a is arranged in the inside of the wire crimping section 31, the wire crimping section 31 and the wire tip 200a are depressed and deformed.

In this case, when the crimping is started simultaneously over the whole wire crimping section 31 or when the crimping of the cover crimping section 31a is started prior to the crimping of the conductor crimping section 31b, air present in the inside of the wire crimping section 31 in a pre-crimping state is not released to the outside at the time of crimping and remains between the wire crimping section 31 and the wire tip 200a and hence, the conductivity between the female crimp terminal 10 and the insulated wire 200 is deteriorated.

In this embodiment, as shown in FIG. 7B, the crimping of the conductor crimping section 31b is started prior to the crimping of the cover crimping section 31a. FIG. 7C shows a state which the female crimp terminal 10 and the insulated wire 200 take in a post-crimping state.

Accordingly, as shown in FIG. 7D, when the crimping of the conductor crimping section 31b is started, air present between the conductor crimping section 31b and the conductor tip 201a moves toward a proximal end side of the wire crimping section 31 due to pressing. Then, when the crimping of the cover crimping section 31a is started, air present between the cover crimping section 31a and the cover tip 202a cannot move toward a distal end side of the wire crimping section 31 and moves toward a proximal end side of the wire crimping section 31, and is released to the outside from the opening of the wire crimping section 31 on a proximal end side of the wire crimping section 31. As a result, by the method of manufacturing the crimp-terminal-equipped wire 1 and the crimping tool 300, air between the wire crimping section 31 and the wire tip 200a can be largely decreased and hence, the conductivity between the female crimp terminal 10 and the insulated wire 200 can be enhanced.

When the crimping is started in order toward the position PO4 from the position PO1 with time or the like, as indicated by an arrow AR1, air present in the wire crimping section 31 can be easily moved toward the proximal end side from the distal end side of the wire crimping section 31 at the time of performing the crimping. Accordingly, by the method of manufacturing the crimp-terminal-equipped wire 1 and the crimping tool 300, an effect of decreasing air between the female crimp terminal 10 and the wire tip 200a can be enhanced.

Further, by binding the above-mentioned plurality of crimp-terminal-equipped wires 1 and by mounting the female crimp terminals 10 of the crimp-terminal-equipped wires 1 into the inside of the female connector housing 3, it is possible to provide the wire harness 2 which ensures the favorable conductivity with the use of the crimp-terminal-equipped wires 1 where the conductivity between the female crimp terminals 10 and the insulated wires 200 is enhanced.

Succeeding to the crimping of the conductor crimping section 31b at the position PO1, the crimping of the conductor crimping section 31b may be performed at the position PO2 in the same step or in another step. Succeeding to the crimping of the cover crimping section 31a at the position PO3, the crimping of the cover crimping section 31a at the position PO4 may be performed in the same step or in another step. Also in these cases, the above-mentioned advantageous effects can be acquired.

Hereinafter, a crimping method according to another embodiment is described.

### Second Embodiment

FIG. 8A and FIG. 8B are operation explanatory views describing a mode of a crimping step of a crimp-terminal-equipped wire 1 according to a second embodiment in cross section. This will be described in more detail. FIG. 8A is a longitudinal cross-sectional view describing a state immediately before a conductor crimping section 31b is crimped to a conductor tip 201a. FIG. 8B is a longitudinal cross-sectional view describing a state immediately before a cover crimping section 31a is crimped to a cover tip 202a.

As shown in FIG. 8A and FIG. 8B, in this embodiment, a crimper is divided into a crimper 301a and a crimper 301b, the crimper 301a and the crimper 301b are configured to be operable independently from each other, and the crimping of the conductor crimping section 31b and the crimping of the cover crimping section 31a are performed in different steps.

This will be described in more detail. As shown in FIG. 8A, first, by clamping a crimping section 30 between the crimper 301a and an anvil 302 from both sides, the conductor crimping section 31b is crimped to the conductor tip 201a. At this point of time, the cover crimping section 31a is not crimped by the crimper 301a.

As shown in FIG. 8B, after the crimping using the crimper 301a is finished, by clamping the crimping section 30 between the crimper 301b and an anvil 302 from both sides, the cover crimping section 31a is crimped to the cover tip 202a. At this point of time, the conductor crimping section 31b may be crimped again to the conductor tip 201a.

Due to such an operation, as shown in FIG. 2, a female crimp terminal 10 can be connected to the wire tip 200a by crimping.

In this embodiment, the crimper is divided into the crimper 301a and the crimper 301b, the crimper 301a and the crimper 301b are configured to be operable independently from each other, and the crimping of the conductor crimping section 31b and the crimping of the cover crimping section 31a are performed in different steps. That is, the crimping of the wire crimping section 31 is performed plural times in a divided manner and hence, it is possible to start the crimping of the conductor crimping section 31b prior to the crimping of the cover crimping section 31a.

Further, as in the case of the wire crimping section 31 where a diameter of the cover crimping section 31a and a diameter of the conductor crimping section 31b are approximately equal, when a compression ratio of the conductor crimping section 31b is large with respect to the compression ratio of the cover crimping section 31a, there may be a case where the cover crimping section 31a is deformed along with the crimping of the conductor crimping section 31b. Accordingly, for example, when the crimping of the cover crimping section 31a is started during the crimping of the conductor crimping section 31b, the deformation caused by the crimping of the conductor crimping section 31b and the deformation caused by the crimping tool 300 are almost simultaneously generated in the cover crimping section 31a. Accordingly, the deformation of the cover crimping section 31a becomes unstable and hence, a gap is formed between the cover crimping section 31a and the cover tip 202a thus giving rise to a drawback that stable water-blocking performance cannot be ensured.

Accordingly, by performing the crimping of the conductor crimping section 31b and the crimping of the cover crimping section 31a in different steps, at the time of crimping the cover crimping section 31a, only the deformation caused by the crimping tool 300 is generated in the cover crimping section 31a. Accordingly, the cover crimping section 31a can crimp the cover tip 202a without forming a gap and hence, the crimp-terminal-equipped wire 1 can ensure the stable water-blocking performance between the cover crimping section 31a and the cover tip 202a.

A cross-sectional shape of a portion of the crimper 301a which presses the conductor crimping section 31b having a normal line in the long length direction X of the wire crimping section 31, and a cross-sectional shape of a portion of the crimper 301b which presses the cover crimping section 31a may be equal or may be different from each other as shown in FIG. 6A and FIG. 6B.

Further, in the above-mentioned embodiment, the crimper is divided into the crimper 301a and the crimper 301b, and the crimping of the conductor crimping section 31b and the crimping of the cover crimping section 31a are performed in different steps. However, it is more desirable that the crimping is performed continuously in the order of the crimping of the conductor crimping section 31b and the crimping of the cover crimping section 31a in this order in one step.

This will be described in more detail. As shown in FIG. 9A which is a cross-sectional view of another crimping step of the second embodiment, a crimper is constituted of a crimper 301a arranged above the conductor crimping section 31b and a crimper 301b arranged above the cover crimping section 31a, and the crimper 301a and the crimper 301b are independently operable from each other.

Then, as shown in FIG. 9B, by pressing the conductor crimping section 31b by an anvil 302 and the crimper 301a, the conductor crimping section 31b and the conductor tip 201a are connected to each other by crimping. Next, as shown in FIG. 10A which is a cross-sectional view showing another crimping step in the second embodiment, in a state where the conductor crimping section 31b is held by the crimper 301a and the anvil 302, the crimper 301b and the anvil 302 presses the cover crimping section 31a thus connecting the cover crimping section 31a and the cover tip 202a to each other by crimping.

Thereafter, as shown in FIG. 10B, in a state where the cover crimping section 31a is clamped between the crimper 301b and the anvil 302, the crimper 301a is moved upward thus releasing the holding of the conductor crimping section 31b. Then, the crimper 301b is moved upward so as to release the holding of the cover crimping section 31a thus providing the crimp-terminal-equipped wire 1.

In this manner, by continuously performing crimping in order of the conductor crimping section 31b and the cover crimping section 31a in one crimping step, the conductivity between the conductor crimping section 31b and the conductor tip 201a can be ensured more reliably.

To be more specific, at the time of crimping the cover crimping section 31a and the cover tip 202a to each other, the conductor crimping section 31b and the conductor tip 201a are held in a crimped state by the crimper 301a and the anvil 302 and hence, the aluminum core wire 201 in the cover tip 202a cannot extend frontward along with the crimping. Accordingly, it is possible to suppress the aluminum core wire 201 in the cover tip 202a from becoming finer and hence, by the method of manufacturing the crimp-terminal-equipped wire 1 and the crimping tool 300, the insulating cover 202 can be strongly compressed at the cover tip 202a.

In this manner, in a crimped state, it is possible to prevent the lowering of a repulsive force of the insulating cover 202 at the cover tip 202a toward the outside in the radial direction. Accordingly, when the holding of the cover crimping section 31a and the cover tip 202a by the crimper 301b and the anvil 302 is released, by the method of manufacturing the crimp-terminal-equipped wire 1 and the crimping tool 300, the formation of a gap between the cover tip 202a and the cover crimping section 31a can be prevented and hence, it is possible to provide the crimp-terminal-equipped wire 1 which can ensure the more reliable water-blocking performance.

Further, when the holding of the crimped wire crimping section 31 is released, there is a possibility that a so-called spring back occurs in the wire crimping section 31 which is a phenomenon where the wire crimping section 31 which is deformed by compression returns to an original shape by resiliency. As a result, there is a possibility that a gap is formed between the wire tip 200a and the wire crimping section 31 in the crimp-terminal-equipped wire 1 and hence, the water-blocking performance is lowered whereby conductivity between the female crimp terminal 10 and the insulated wire 200 is lowered.

To the contrary, by crimping the conductor crimping section 31b and the cover crimping section 31a in this order and also by releasing the holding of the conductor crimping section 31b and the cover crimping section 31a in this order, it is possible to suppress the spring back of the cover crimping section 31a which may follow the spring back of the conductor crimping section 31b. Accordingly, by the method of manufacturing the crimp-terminal-equipped wire 1 and the crimping tool 300, the crimp-terminal-equipped wire 1 can be provided which suppresses the lowering of water-blocking performance attributed to the formation of a gap between the cover tip 202a and the wire crimping section 31.

In addition to the above, by continuously crimping the conductor crimping section 31b and the cover crimping section 31a in this order, air present between the conductor crimping section 31b and the conductor tip 201a moves toward a proximal end side of the wire crimping section 31 and, at the same time, air present between the cover crimping section 31a and the cover tip 202a moves toward the proximal end side of the wire crimping section 31 and is discharged to the outside from the opening of the wire crimping section 31 on the proximal end side.

Accordingly, by the method of manufacturing the crimp-terminal-equipped wire 1 and the crimping tool 300, the female crimp terminal 10 and the insulated wire 200 can be efficiently crimped to each other and, at the same time, the conductivity between the conductor crimping section 31b and the conductor tip 201a can be reliably ensured.

### Third Embodiment

FIG. 11 is an operation explanatory view describing a mode of a crimping step of a crimp-terminal-equipped wire 1 according to a third embodiment in cross section. This will be described in more detail. FIG. 11 is a longitudinal cross-sectional view showing a state immediately before a female crimp terminal 10 is crimped to a wire tip 200a.

As shown in FIG. 11, in this embodiment, an inclination extending in a direction toward an anvil 302 (lower side in FIG. 11) is provided to a portion (bottom portion 311a) of a crimper 301 which presses a wire crimping section 31.

This will be described in more detail. The portion of the crimper 301 which presses the cover crimping section 31a projects in the direction toward the anvil 302. That is, the portion of the crimper 301 ranging from a portion which presses a proximal-end-side end portion PO4 of the cover crimping section 31a to a portion which presses a distal-end-side end portion PO3 of the cover crimping section 31a projects in the direction toward the anvil 302. Further, a portion of the crimper 301 which presses a conductor crimping section 31b projects in the direction toward the anvil 302 (lower side in FIG. 11). That is, the portion of the crimper 301 ranging from a portion which presses a proximal-end-side end portion PO2 of the conductor crimping section 31b to a portion which presses a distal-end-side end portion PO1 of the conductor crimping section 31b projects in the direction toward the anvil 302. The portion of the crimper 301 which presses the proximal-end-side end portion PO2 of the conductor crimping section 31b projects more in the direction toward the anvil 302 than the portion of the crimper 301 which presses the distal-end-side end portion PO3 of the cover crimping section 31a.

As in the case of this embodiment, by providing the inclination extending in the direction toward the anvil 302 to the portion of the crimper 301 which crimps the wire crimping section 31, in the method of manufacturing the crimp-terminal-equipped wire 1 and the crimping tool 300, the crimping of the conductor crimping section 31b can be started prior to the crimping of the cover crimping section 31a.

To describe the correspondence between the configuration of this invention and the configuration of the above-mentioned embodiment, they are as follows.

The connection structural body of this invention corresponds to the crimp-terminal-equipped wire 1 of the embodiment.

In the same manner,

the crimp terminal of this invention corresponds to the female crimp terminal 10 of the embodiment,

the conductor of this invention corresponds to the aluminum core wire 201 of the embodiment,

the portion which crimps the conductor tip of this invention corresponds to the first position of the wire crimping section 31 in the long length direction X in the embodiment,

the portion which crimps the cover tip of this invention corresponds to the second position of the wire crimping section 31 in the long length direction X in the embodiment,

the crimping device of this invention corresponds to the crimping tool 300 of the embodiment,

the crimping member of this invention corresponds to the crimper 301, 301a, 301b and the anvil 302 of the embodiment,

the first die of this invention corresponds to the crimper 301, 301a, 301b of the embodiment,

the second die of this invention corresponds to the anvil 302 of the embodiment, and

a connector housing of this invention corresponds to the female connector housing 3, and the male connector housing 5 of the embodiment.

However, this invention is not limited to the configuration of the above-mentioned embodiments, and various applications can be made based on the technical concept called for in claims, and this invention can take various embodiments.

For example, the constitutions of the crimp-terminal-equipped wires 1, the methods of manufacturing the crimp-terminal-equipped wire 1, and the constitutions of the crimping tools 300 according to the first, second and third embodiments are not limited to the above-mentioned constitutions and the methods of manufacturing the crimp-terminal-equipped wire 1.

To be specific, to allow the crimping of the conductor crimping section 31b to be started prior to the crimping of the cover crimping section 31a, a recessed portion having a width WD2 as shown in FIG. 6E may be formed not on the crimper 301 but on the anvil 302, for example.

A core wire made of an aluminum alloy is used as a core wire of the insulated wire 200. However, the core wire of the insulated wire 200 is not limited to such a core wire. A core wire made of a copper alloy such as brass, a core wire where an outer peripheral surface of an aluminum alloy is covered with a copper alloy, a core wire formed of suitable metal wires having conductivity or the like may be used as the core wire of the insulated wire 200.

A copper alloy such as brass is used as a material for forming the female crimp terminal 10. However, a material for forming the female crimp terminal 10 is not limited to a copper alloy, and the female crimp terminal 10 may be made of an aluminum alloy or a suitable metal having conductivity.

The crimping section 30 is formed such that a copper alloy strip is blanked into a terminal shape, and end portions 32a of the rounded copper alloy strip are abutted and welded to each other. However, a method of forming the crimping section 30 is not limited to such a method, and the crimping section 30 may be a crimping section having a closed cross-sectional shape where overlapped end portions 32a are welded to each other thus forming an integral body.

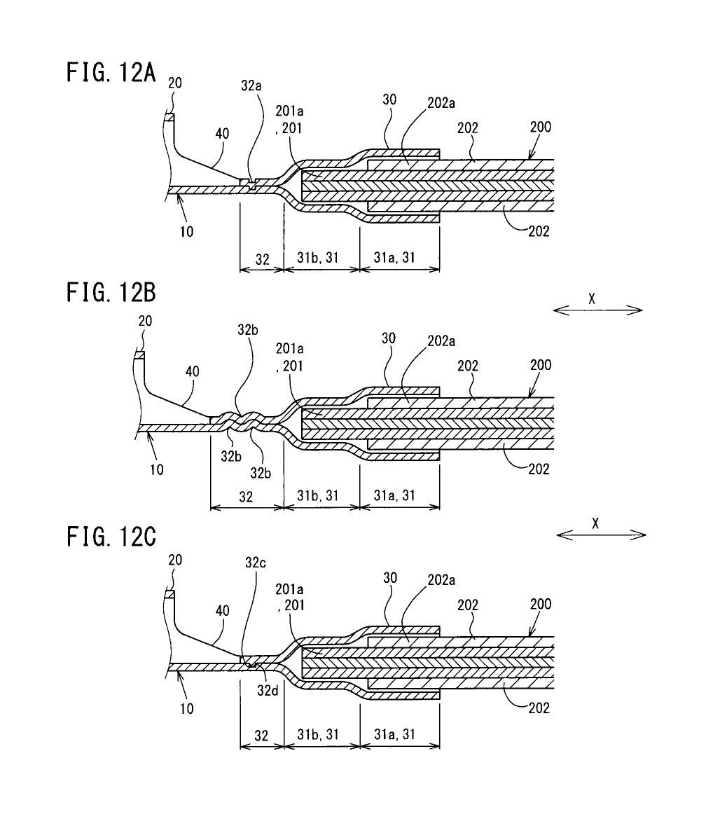

The crimping section 30 is formed into a cylindrical shape where the cover crimping section 31a and the conductor crimping section 31b have the same diameter. However, the shape of the crimping section 30 is not limited to such a shape, and provided that the crimping section 30 has a closed cross-sectional shape into which the insulated wire 200 can be inserted, the crimping section 30 may be formed into any suitable shape. For example, as shown in FIG. 12A to FIG. 12C which are cross-sectional views of another crimping section 30, the crimping section 30 may have a stepped shape where a diameter of a cover crimping section 31a and a diameter of the conductor crimping section 31b differ from each other.

The sealing portion 32 is formed on a front end of the crimping section 30. However, the method of forming the sealing portion 32 is not limited to such a method, and the sealing portion 32 may be formed by sealing the front end of the crimping section 30 with an additional member. Alternatively, as shown in FIG. 12A, the sealing portion 32 may be formed such that an end portion in front of the conductor crimping section 31b is depressed into an approximately plate shape, and a recessed groove 32b having an approximately recessed shape along the width direction Y is integrally formed in the end portion.

Further, as shown in FIG. 12B, the sealing portion 32 may be formed such that an end portion in front of the conductor crimping section 31b is depressed into an approximately wave shape thus forming the sealing portion 32 constituted of a plurality of recessed grooves 32b along the width direction Y. Further, as shown in FIG. 12C, the sealing portion 32 may be formed such that a tenon 32c and a tenon groove 32d are provided to an end portion in front of the conductor crimping section 31b and the end portion is depressed so that the tenon 32c and the tenon groove 32d engage with each other by fitting engagement thus forming the sealing portion 32. The crimping section may have both ends thereof in the long length direction X open-ended without forming the sealing portion 32.

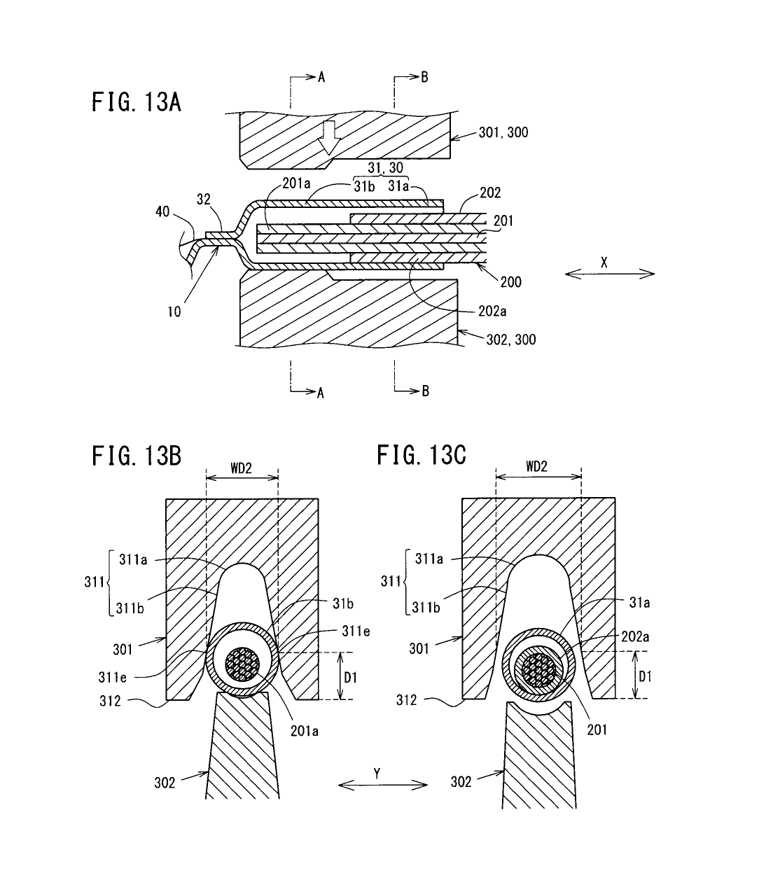

A portion of the anvil 302 which faces the wire crimping section 31 in an opposed manner is formed with a uniform depth along the long length direction X. However, the portion of the anvil 302 is not limited to such a shape. That is, as shown in FIG. 13A which is a cross-sectional view showing another crimping tool 300 and the crimping section 30, a portion of the anvil 302 which faces the conductor crimping section 31b may have an upwardly projecting shape.

In this case, when the conductor crimping section 31b is placed on the portion of the anvil 302 which faces the conductor crimping section 31b in an opposed manner, a rear end of the cover crimping section 31a is inclined downward. Accordingly, along with the crimping, neck breaking occurs in the wire crimping section 31 or a crimping failure or a crimping irregularity is generated due to play in the wire crimping section 31 thus giving rise to a possibility that a stable crimping state cannot be ensured.

In view of the above, as shown in FIG. 13B and FIG. 13C, at a predetermined depth D1 of the crimper 301, a width WD2 of the communicating portion 311b which corresponds to the conductor crimping section 31b is set smaller than a width WD2 of the communicating portion 311b which corresponds to the cover crimping section 31a.

When the crimping is started, the crimper 301 is first brought into contact with the conductor crimping section 31b and, at the same time, the conductor crimping section 31b can be gripped by the communicating portion 311b which corresponds to the conductor crimping section 31b and the anvil 302. In such a stage, the crimping tool 300 can lift the cover crimping section 31a from the anvil 302 such that the cover crimping section 31a is spaced apart from the crimper 301 and the anvil 302 with predetermined gaps formed therebetween.

Due to such a constitution, the crimping tool 300 can perform the positioning of the cover crimping section 31a with respect to the crimper 301 and the anvil 302 along with the crimping of the conductor crimping section 31b. Accordingly, the crimping tool 300 can crimp the cover crimping section 31a with higher accuracy so that neck breaking of the wire crimping section 31, a crimping failure or a crimping irregularity due to play in the wire crimping section 31 can be suppressed. Accordingly, the crimping tool 300 can crimp the wire crimping section 31 and the insulated wire 200 to each other with high accuracy and, at the same time, can ensure more reliable conductivity.

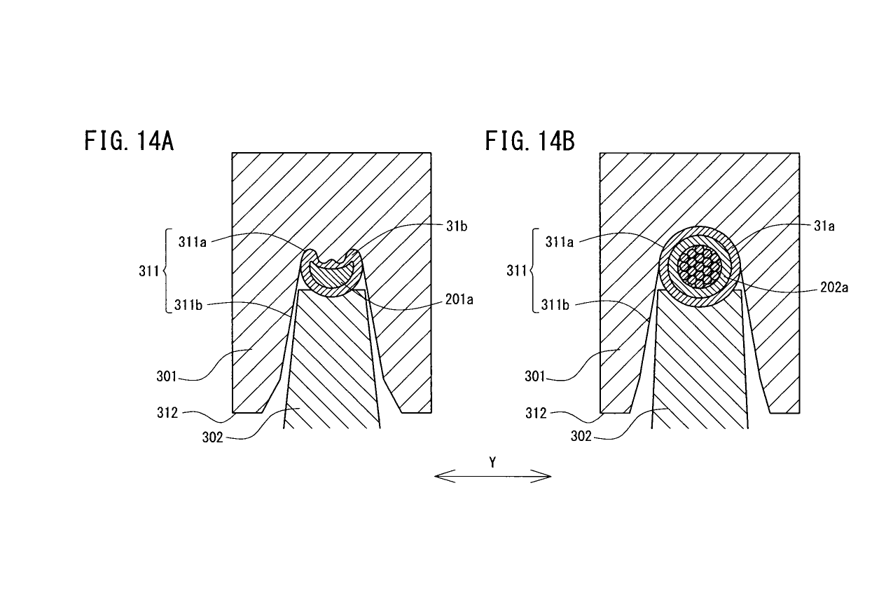

The crimping section 30 adopts a crimped shape where the conductor crimping section 31b and the cover crimping section 31a are crimped to each other by decreasing the diameters of the conductor crimping section 31b and the cover crimping section 31a. However, the crimped shape of the crimping section 30 is not limited to such a crimped shape. For example, as in the case shown in FIG. 14A and FIG. 14B which are cross-sectional views of another crimped shape of the crimping section 30 of the female crimp terminal 10, the crimping section 30 may adopt a crimped shape where the cover crimping section 31a is crimped in the same manner as in the above-mentioned embodiment, while the conductor crimping section 31b is crimped so as to have a recessed cross-sectional shape where the approximately center of an upper portion of the conductor crimping section 31b in the width direction Y is recessed. In this case, a bottom portion 311a of the crimper 301 which presses the conductor crimping section 31b is formed into a shape which projects toward the anvil 302.

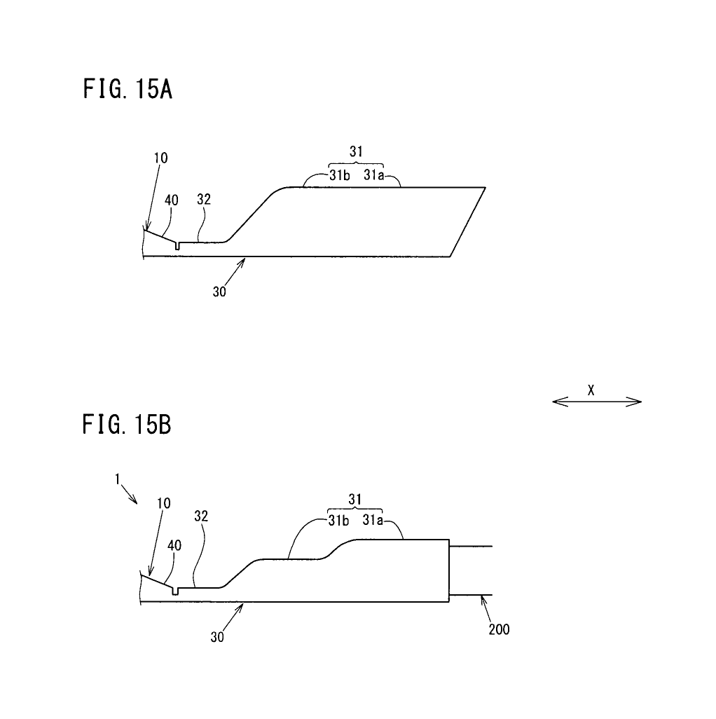

In the wire crimping section 31 which is formed such that the conductor crimping section 31b and the cover crimping section 31a have substantially the same diameter, an opening end portion on a rear side is formed substantially vertically as viewed in a side view. However, the configuration of the opening end portion of the wire crimping section 31 is not limited to the above. By taking into account the difference between a compression ratio of the conductor crimping section 31b and a compression ratio of the cover crimping section 31a, the opening end portion of the wire crimping section 31 on the rear side may be inclined. For example, as shown in FIG. 15A which is an explanatory view for describing a crimping section 30 of another female crimp terminal 10, the female crimp terminal 10 may adopt the wire crimping section 31 where an upper portion of an opening end portion is inclined toward a rear side as viewed in a side view.

Due to such a constitution, the upper portion of the opening end portion is pulled frontwardly along with the crimping of the conductor crimping section 31b and hence, as shown in FIG. 15B, in a crimped state, the opening end portion of the wire crimping section 31 assumes a substantially vertical state as viewed in a side view. Accordingly, the female crimp terminal 10 can be crimped to the insulated wire 200 in a crimped state having a favorable appearance.

To bring an opening end portion of the wire crimping section 31 into a substantially vertical state in a post-crimping state as viewed in a side view, the opening end portion of the wire crimping section 31 may be formed as follows. The opening end portion of the wire crimping section 31 on a rear side may be inclined frontwardly or rearwardly in accordance with a shape of the crimping tool 300 or a state of deformation of the wire crimping section 31 which is generated along with the crimping of the conductor crimping section 31b and the crimping of the cover crimping section 31a.

### DESCRIPTION OF REFERENCE SIGNS

1: Crimp-terminal-equipped wire

2: Wire harness

3: Female connector housing

4: Wire harness

5: Male connector housing

10: Female crimp terminal

30: Crimping section

31a: Cover crimping section

31b: Conductor crimping section

200: Insulated wire

200a: Wire tip

201: Aluminum core wire

201a: Conductor tip

202: Insulating cover

202a: Cover tip

300: Crimping tool

301, 301a, 301b: Crimper

302: Anvil

311: Recessed portion

311a: Bottom portion

311b: Communicating portion

WD2: Width of communicating portion at specified depth

1. A method of manufacturing a connection structural body where an insulated wire formed by covering a conductor with an insulating cover and a crimp terminal provided with a crimping section which allows the crimping connection of a wire tip of the insulated wire are connected by crimping to each other by the crimping section, wherein
the wire tip is constituted of a conductor tip which is formed by exposing the conductor by peeling off the insulating cover on a distal end side of the insulated wire, and a cover tip formed on a distal end portion of the insulating cover,
the crimping section is configured to have a hollow cross-sectional shape, includes a sealing portion which seals a portion on a distal end side of the crimping section, and is also configured by arranging a conductor crimping section which crimps the conductor tip and a cover crimping section which crimps the cover tip, and
the wire tip is arranged in the inside of the crimping section, and the crimping of the conductor crimping section is started prior to the crimping of the cover crimping section thus crimping the conductor crimping section and the cover crimping section to each other by deforming at least a proximal end side of the conductor crimping section and a distal end side of the cover crimping section in a crimping step where the crimping section is connected to the wire tip by crimping.

2. The method of manufacturing a connection structural body according to claim 1, wherein, in the crimping step, the crimping is started toward a proximal-end-side end portion of the conductor crimping section from a distal-end-side end portion of the conductor crimping section sequentially.

3. The method of manufacturing a connection structural body according to claim 2, wherein, in the crimping step, the crimping is started toward a proximal-end-side end portion of the cover crimping section from a distal-end-side end portion of the cover crimping section sequentially.

4. The method of manufacturing a connection structural body according to claim 1, wherein, in the crimping step,
the crimping of the conductor crimping section and the crimping of the cover crimping section are performed in a same step.

5. The method of manufacturing a connection structural body according to claim 1, wherein, in the crimping step,
the crimping of the conductor crimping section and the crimping of the cover crimping section are performed in different steps.

6. A connection structural body manufactured by the method of manufacturing a connection structural body according to claim 1.

7. The connection structural body according to claim 6., wherein the crimp terminal is made of copper or a copper alloy, and the conductor of the insulated wire is made of aluminum or an aluminum alloy.

8. A wire harness configured such that a plurality of connection structural bodies according to claim 6 are bound together and the crimp terminals of the connection structural bodies are mounted in the inside of a connector housing.

9. A crimping member for connecting a wire tip of an insulated wire formed by covering a conductor with an insulating cover to a crimp terminal provided with a crimping section by crimping in a state where the wire tip which is formed of a conductor tip formed by exposing the conductor by peeling off the insulating cover on a distal end side and a cover tip formed on a distal end portion of the insulating cover is arranged in the inside of the crimping section of the crimp terminal which is formed in a hollow cross-sectional shape and is formed by arranging a conductor crimping section which crimps the conductor tip and a cover crimping section which crimps the cover tip, wherein
the crimping member comprises a first die and a second die which engages with the first die, and a recessed portion is formed on the first die at a position which faces the second die in an opposed manner,
the recessed portion is constituted of a bottom portion which defines a shape of the crimp terminal after crimping, and a communicating portion which makes the bottom portion and the outside communicate with each other, and has a width thereof when viewed in a cross section having a normal line along the long length direction of the crimp terminal increased toward an opening portion of the recessed portion from a boundary portion with the bottom portion,
the crimping member further comprises: a portion which crimps the conductor tip formed by exposing the conductor by peeling off the insulating cover on the distal end side of the insulated wire, and a portion which crimps the cover tip formed on the distal end portion of the insulating cover,
the width of a portion of the communicating portion which is brought into contact with the crimping section and starts crimping in the portion which crimps the conductor tip is set smaller than the width of a portion having a height of the recessed portion of the portion which crimps the cover tip corresponding to the portion which starts crimping, and
the crimping of the portion which crimps the conductor tip is started prior to the crimping of the portion which crimps the cover tip by bringing the portion which crimps the conductor tip into contact with the crimp terminal earlier than the portion which crimps the cover tip thus crimping the conductor crimping section and the cover crimping section to each other by deforming at least a proximal end side of the conductor crimping section and a distal end side of the cover crimping section.

10. A crimping device for connecting a wire tip of an insulated wire formed by covering a conductor with an insulating cover to a crimp terminal by crimping in a state where the wire tip which is formed of a conductor tip formed by exposing the conductor by peeling off the insulating cover on a distal end side and a cover tip formed on a distal end portion of the insulating cover is arranged in the inside of a crimping section of the crimp terminal which is formed in a hollow cross-sectional shape and is formed by arranging a conductor crimping section which crimps the conductor tip and a cover crimping section which crimps the cover tip, wherein
the crimping device comprises a crimping member which crimps the crimp terminal,
the crimping member includes a first die and a second die which engages with the first die, and a recessed portion is formed on the first die at a position which faces the second die in an opposed manner,
the recessed portion is constituted of a bottom portion which defines a shape of the crimp terminal after crimping, and a communicating portion which makes the bottom portion and the outside communicate with each other, and has a width thereof when viewed in a cross section having a normal line along the long length direction of the crimp terminal increased toward an opening portion of the recessed portion from a boundary portion with the bottom portion,
the crimping member further includes: a portion which crimps the conductor tip formed by exposing the conductor by peeling off the insulating cover on the distal end side of the insulated wire, and a portion which crimps the cover tip formed on the distal end portion of the insulating cover,
the width of a portion of the communicating portion which is brought into contact with the crimping section and starts crimping in the portion which crimps the conductor tip is set smaller than the width of a portion having a height of the recessed portion of the portion which crimps the cover tip corresponding to the portion which starts crimping, and
the crimping of the portion which crimps the conductor tip is started prior to the crimping of the portion which crimps the cover tip by bringing the portion which crimps the conductor tip into contact with the crimp terminal earlier than the portion which crimps the cover tip thus crimping the conductor crimping section and the cover crimping section by deforming at least a proximal end side of the conductor crimping section and a distal end side of the cover crimping section.
